(19) United States
(12) Patent Application Publication
(10) Pub. No.: US 2026/0100381 A1
(43) Pub. Date: Apr. 9, 2026

(54) CURRENT COLLECTOR AND BATTERY

(71) Applicant: TOYOTA JIDOSHA KABUSHIKI KAISHA, Toyota-shi (JP)

(72) Inventors: Atsushi SUGIHARA, Toyota-shi (JP); Tetsuya MIMURA, Chiryu-shi (JP); Satoshi MORIYAMA, Nagoya-shi (JP); Masayoshi HAGA, Nagoya-shi (JP); Masaki FURUKAWA, Toyota-shi (JP); Keita YAMASHITA, Nagoya-shi (JP); Ryuto SAKAMOTO, Okazaki-shi (JP); Hideyuki NAGAI, Nagoya-shi (JP)

(73) Assignee: TOYOTA JIDOSHA KABUSHIKI KAISHA, Toyota-shi (JP)

(21) Appl. No.: 19/229,153

(22) Filed: Jun. 5, 2025

(30) Foreign Application Priority Data
Oct. 4, 2024 (JP) 2024-175182

(51) Int. Cl. H01M 4/66; H01M 50/533; H01M 50/536; H01M 50/538

(52) U.S. Cl. CPC H01M 4/668; H01M 50/533; H01M 50/536; H01M 50/538

(57) ABSTRACT

A current collector includes a support layer, a first electrically conductive layer, and a tab portion. The support layer is composed of a resin composition having electric insulation. The first electrically conductive layer is laminated on the support layer. The tab portion is constituted by a film-formed member. The tab portion includes a tab body portion and a first heat release portion. The tab body portion is joined to the first electrically conductive layer by ultrasonic welding. The tab body portion extends so as to be away from the first electrically conductive layer. The first heat release portion is shorter than the tab body portion, in an extension direction of the tab body portion. The first heat release portion is not joined to the first electrically conductive layer by ultrasonic welding.

### CROSS-REFERENCE TO RELATED APPLICATION

This application claims priority to Japanese Patent Application No. 2024-175182 filed on Oct. 4, 2024. The disclosure of the above-identified application, including the specification, drawings, and claims, is incorporated by reference herein in its entirety.

### BACKGROUND

### 1. Technical Field

The present disclosure relates to a current collector and a battery.

### 2. Description of Related Art

Japanese Unexamined Patent Application Publication (Translation of PCT Application) No. 2024-510696 (JP 2024-510696 A) discloses a conventional polar plate. The polar plate includes a current collector, an active material layer, and an electric connection member. The current collector includes a support layer and an electrically conductive layer. The electrically conductive layer is provided on one surface of the support layer. In the current collector, the electrically conductive layer plays roles for electric conduction and current collection, and provides electrons for the active material layer. The electric connection member and the current collector are connected by welding, at an edge of the current collector. A region of the connection by welding is called a welding-junction region.

### SUMMARY

At the welding-junction region, the electric resistance value is relatively high. Therefore, at the time of the energization of the current collector, relatively great heat generation occurs at the welding-junction region. However, the addition of a shape or a member for restraining heat generation can increase the production cost for the current collector, and increases the weight.

The present disclosure has been made in view of the above problem, and has an object to provide a current collector that makes it possible to restrain heat generation at the time of energization while restraining the increase in production cost and the increase in weight, and a battery including the current collector.

A current collector according to an aspect of the present disclosure includes a support layer, a first electrically conductive layer, and a tab portion. The support layer is composed of a resin composition having electric insulation. The first electrically conductive layer is laminated on the support layer. The tab portion is constituted by a film-formed member. The tab portion includes a tab body portion and a first heat release portion. The tab body portion is joined to the first electrically conductive layer by ultrasonic welding. The tab body portion extends so as to be away from the first electrically conductive layer. The first heat release portion is shorter than the tab body portion, in an extension direction of the tab body portion. The first heat release portion is not joined to the first electrically conductive layer by ultrasonic welding.

A battery according to an aspect of the present disclosure includes an electrode body and an external terminal. The electrode body includes a first electrode, a second electrode, and a separator. The first electrode includes a current collector and an active material layer. The current collector includes a support layer, a first electrically conductive layer, and a tab portion. The support layer is composed of a resin composition having electric insulation. The first electrically conductive layer is laminated on the support layer. The tab portion is constituted by a film-formed member. The tab portion includes a tab body portion and a first heat release portion. The tab body portion is joined to the first electrically conductive layer by ultrasonic welding. The tab body portion extends so as to be away from the first electrically conductive layer. The first heat release portion is shorter than the tab body portion, in an extension direction of the tab body portion. The first heat release portion is not joined to the first electrically conductive layer by ultrasonic welding. The active material layer is laminated on the first electrically conductive layer. The separator is laminated on the active material layer. The second electrode is laminated on the active material layer through the separator. The external terminal is electrically connected with the tab body portion.

The above configurations make it possible to restrain heat generation at the time of energization while restraining the increase in production cost the increase in weight.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view showing a battery according to Embodiment 1;

FIG. 2 is a sectional view of an electrode body as viewed in a direction of arrow line II-II in FIG. 1;

FIG. 3 is a schematic sectional view of the electrode body as partially viewed in a direction of arrow line III-III in FIG. 1;

FIG. 4 is a developed view of a first electrode;

FIG. 5A is a partial sectional view of the first electrode as viewed in a direction of arrow line VA-VA in FIG. 4;

FIG. 5B is a partial sectional view of the first electrode as viewed in a direction of arrow line VB-VB in FIG. 4; and

FIG. 6 is a partial sectional view of a first electrode in Embodiment 2.

### DETAILED DESCRIPTION OF EMBODIMENTS

Current collectors and batteries according to embodiments of the present disclosure will be described below with reference to the drawings. In the figures, identical or corresponding portions are denoted by identical reference characters, and descriptions thereof are not repeated.

### Embodiment 1

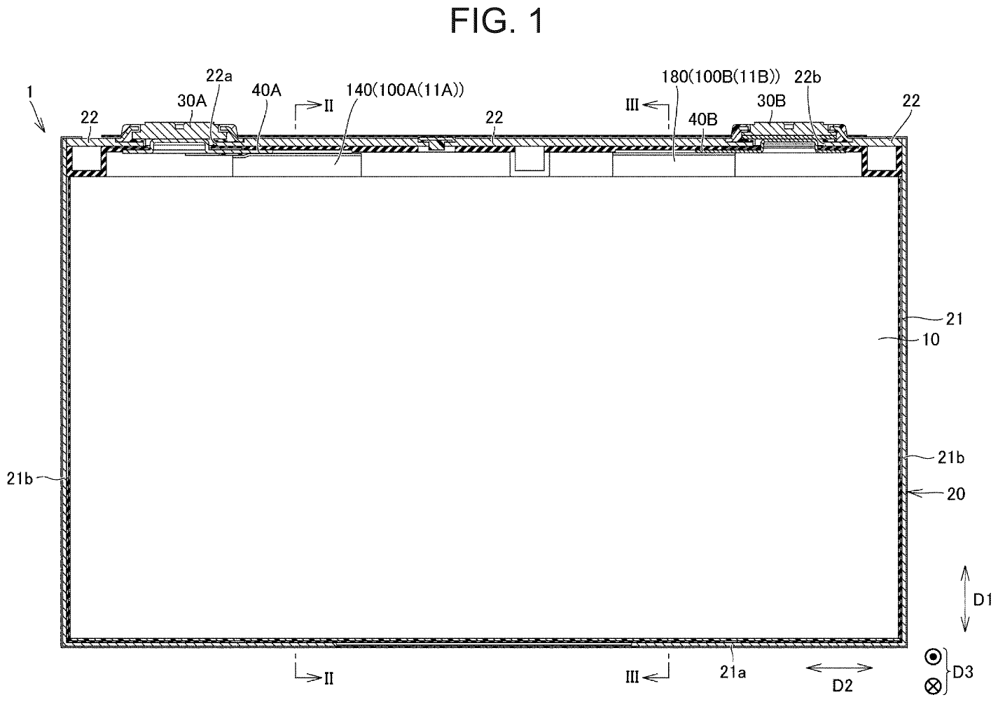

FIG. 1 is a sectional view showing a battery according to Embodiment 1. A battery 1 shown in FIG. 1 is a so-called rectangular battery. The battery 1 may be a secondary battery configured such that charging and discharging can be performed, as exemplified by a lithium-ion battery and a nickel-hydrogen battery. For example, the battery 1 can be used as a cell included in an electricity storage module that is mounted on an electrified vehicle.

As shown in FIG. 1, the battery 1 according to Embodiment 1 of the present disclosure includes an electrode body 10, a case 20, a first external terminal 30A, a second external terminal 30B, a first coupling member 40A, and a second coupling member 40B. First, constituents of the battery 1 other than the electrode body 10 will be described.

The case 20 has electric conductivity. A portion that is of the case 20 and that has electric conductivity is composed of a metal such as aluminum, for example. The case 20 houses the electrode body 10. The case 20 also houses an unillustrated electrolytic solution.

The case 20 includes a case body 21 and a lid 22. The case body 21 includes a bottom wall 21a and a peripheral wall 21b that stands from the bottom wall 21a.

The lid 22 is joined to the peripheral wall 21b by welding or the like, so as to close an opening of the peripheral wall 21b. On the lid 22, a first coupling hole 22a and a second coupling hole 22b are formed.

The first external terminal 30A and the second external terminal 30B are provided on the battery 1, so as to be exposed to the exterior. The first coupling member 40A and the second coupling member 40B have electric conductivity. At least a part of the first coupling member 40A and at least a part of the second coupling member 40B are disposed in the interior of the case 20.

The first external terminal 30A or the first coupling member 40A is inserted into the first coupling hole 22a. The first external terminal 30A is electrically connected with the first coupling member 40A. Specifically, the first external terminal 30A and the first coupling member 40A are joined to each other. The first coupling member 40A is joined to the electrode body 10. Thereby, the first external terminal 30A is electrically connected with the electrode body 10.

The second external terminal 30B or the second coupling member 40B is inserted into the second coupling hole 22b. The second external terminal 30B is electrically connected with the second coupling member 40B. Specifically, the second external terminal 30B and the second coupling member 40B are joined to each other. The second coupling member 40B is joined to the electrode body 10. Thereby, the second external terminal 30B is electrically connected with the electrode body 10.

In the embodiment, the first external terminal 30A is a positive electrode terminal, and the second external terminal 30B is a negative electrode terminal. The first external terminal 30A and the second external terminal 30B are arrayed in a second direction D2. The second direction D2 is a direction orthogonal to a first direction D1.

Next, the electrode body 10 will be described. The battery 1 according to the embodiment includes a plurality of electrode bodies 10. Typically, the battery 1 includes two electrode bodies 10. The electrode bodies 10 are arrayed in a third direction D3. The third direction D3 is a direction orthogonal to both of the first direction D1 and the second direction D2.

One electrode body 10 of the electrode bodies 10 will be described below. Each of the electrode bodies 10 may have the following configuration.

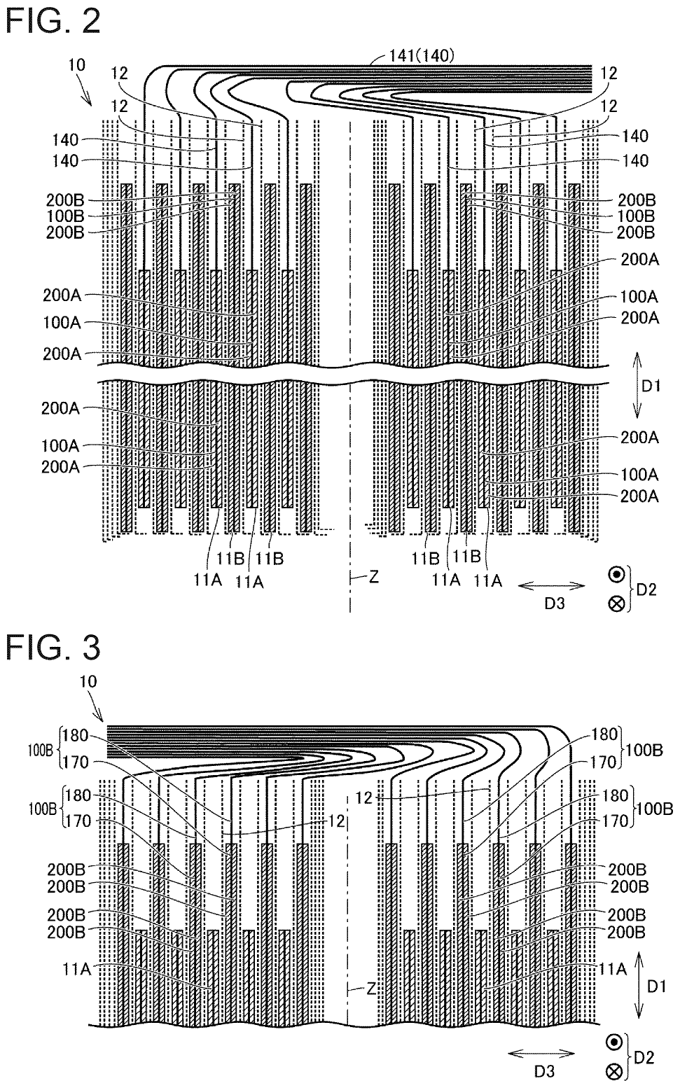

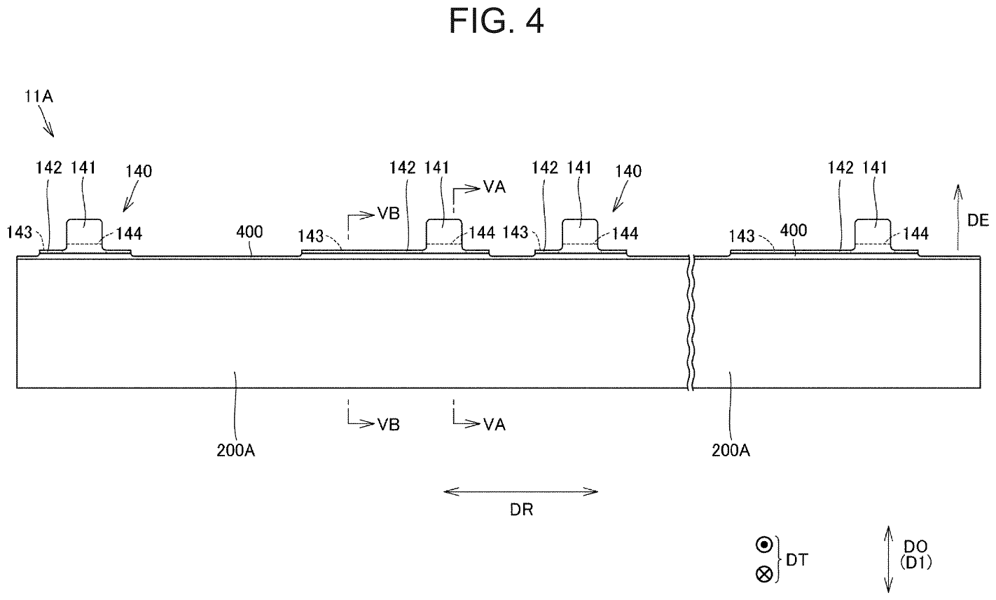

FIG. 2 is a sectional view of the electrode body as viewed in a direction of arrow line II-II in FIG. 1. FIG. 3 is a schematic sectional view of the electrode body as partially viewed in a direction of arrow line III-III in FIG. 1. As shown in FIG. 1 to FIG. 3, the electrode body 10 includes a first electrode 11A, a second electrode 11B, and a separator 12. In the electrode body 10, the first electrode 11A, the second electrode 11B, and the separator 12 are wound so as to surround the periphery of a winding axis line Z. In this way, in the embodiment, the electrode body 10 is a so-called wound electrode body. However, the electrode body 10 may be a laminated electrode body in which the first electrode 11A, the second electrode 11B, and the separator 12 are laminated in one direction (for example, the third direction D3). In FIG. 2 and FIG. 3, the separator 12 is schematically shown by broken lines.

Each external shape of the first electrode 11A and the second electrode 11B is a sheet shape. The electrode body 10 is constituted by a polar plate group in which the first electrode 11A and the second electrode 11B are wound through one or more separators 12.

In the embodiment, the first electrode 11A is a positive electrode, and the second electrode 11B is a negative electrode. However, the first electrode 11A may be a negative electrode, and the second electrode 11B may be a positive electrode.

The separator 12 is provided between the first electrode 11A and the second electrode 11B. The separator 12 separates the first electrode 11A and the second electrode 11B, while allowing the movement of ions between the first electrode 11A and the second electrode 11B. The ions are lithium ions, for example. The separator 12 has electric insulation.

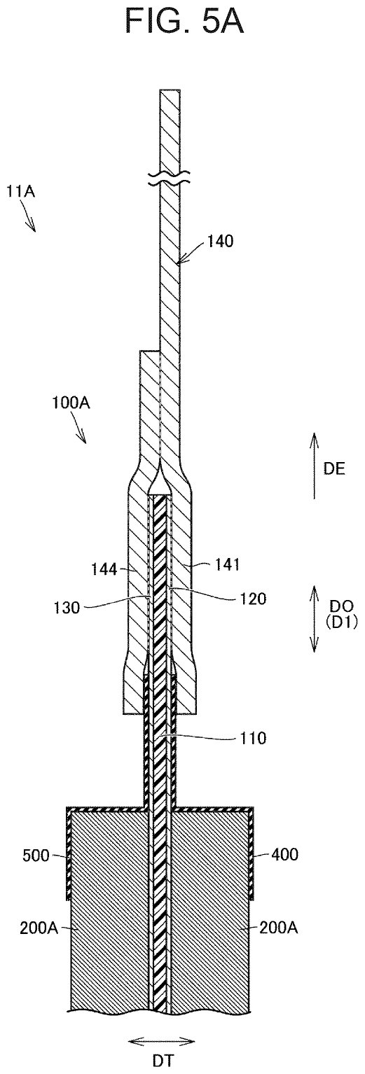

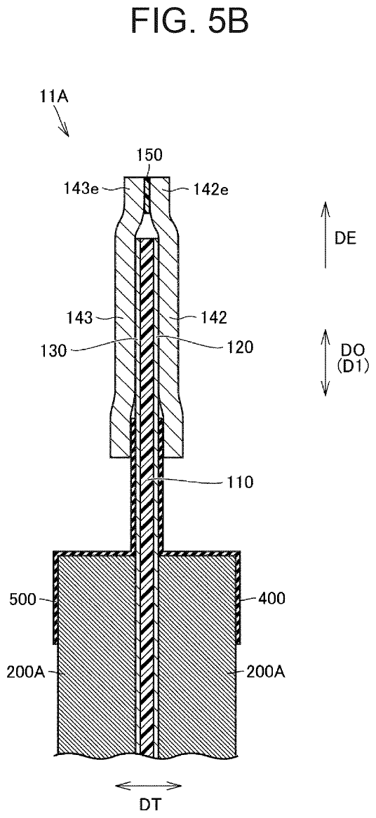

FIG. 4 is a developed view of the first electrode. That is, FIG. 4 shows a state before the first electrode 11A is wound. FIG. 5A is a partial sectional view of the first electrode as viewed in a direction of arrow line VA-VA in FIG. 4. FIG. 5B is a partial sectional view of the first electrode as viewed in a direction of arrow line VB-VB in FIG. 4.

As shown in FIG. 2 to FIG. 5B, the first electrode 11A includes a first current collector 100A, a first active material layer 200A, a first protection portion 400, and a second protection portion 500.

The first current collector 100A includes a support layer 110, a first electrically conductive layer 120, a second electrically conductive layer 130, a plurality of tab portions 140, and a plurality of adhesion members 150.

The support layer 110 is composed of a resin composition having electric insulation. Therefore, the first current collector 100A is a composite current collector constituted by an electrically conductive member and an electrically insulating member. Thereby, the first current collector 100A is lighter and the safety of the whole of the battery 1 is higher, compared to a case where the whole of the first current collector 100A is composed of a metal.

The support layer 110 is composed of a resin composition containing polyamide resin, polyester resin, or polyolefin resin, for example. For high stiffness, it is preferable that the support layer 110 is composed of a resin composition containing polyester resin. It is further preferable that the support layer 110 is substantially composed of polyester resin. The polyester resin may be polyethylene terephthalate, for example. Thereby, it is possible to increase the stiffness of the first current collector 100A, while maintaining the electric insulation of the support layer 110. Furthermore, it is possible to relatively thin the support layer 110.

An orthogonal direction DO that is orthogonal to a thickness direction DT of the support layer 110 is roughly parallel to the first direction D1. That is, the support layer 110 extends roughly parallel to the first direction D1.

For reducing the whole thickness of the electrode body 10, the thickness of the support layer 110, for example, preferably should be 20 μm or less, more preferably should be 15 μm or less, and further preferably should be 10 μm or less. The thickness of the support layer 110 is not particularly limited as long as there is a desired stiffness. For example, the thickness of the support layer 110 may be 2 μm or more.

The first electrically conductive layer 120 is laminated on the support layer 110. The first electrically conductive layer 120 is provided on one surface of the support layer 110. The first electrically conductive layer 120 is provided over the whole of the one surface.

In the embodiment, the first electrically conductive layer 120 is positioned on the side of the winding axis line Z relative to the support layer 110. However, the first electrically conductive layer 120 may be positioned on the opposite side of the support layer 110 from the side of the winding axis line Z.

The second electrically conductive layer 130 is laminated on the support layer 110, so as to be opposed to the first electrically conductive layer 120. That is, the second electrically conductive layer 130 is provided on the other surface of the support layer 110. The second electrically conductive layer 130 is provided over the whole of the other surface.

The thickness of the first electrically conductive layer 120 and the thickness of the second electrically conductive layer 130 are smaller than the thickness of the support layer 110. For reducing the whole thickness of the electrode body 10, the thickness of the first electrically conductive layer 120 and the thickness of the second electrically conductive layer 130, for example, are 5 μm or less, more preferably should be 2 μm or less, and further preferably should be 1 μm or less. For restraining the electric resistance of the first electrically conductive layer 120 and the second electrically conductive layer 130 from being excessively high, the thickness of the first electrically conductive layer 120 and the thickness of the second electrically conductive layer 130 may be 0.1 μm or more, for example. In the case where the thickness of the first electrically conductive layer 120 and the thickness of the second electrically conductive layer 130 are 5 μm or less, it is difficult for the first electrically conductive layer 120 and the second electrically conductive layer 130 to be directly welded to each other or to be directly joined to each other by ultrasonic welding.

A method for forming the first electrically conductive layer 120 and the second electrically conductive layer 130 is not particularly limited. Typically, by a deposition method or the like, the first electrically conductive layer 120 and the second electrically conductive layer 130 may be provided on the support layer 110. Each of the first electrically conductive layer 120 and the second electrically conductive layer 130 may be constituted by a metal film. In this case, the first electrically conductive layer 120 and the second electrically conductive layer 130 may adhere to the support layer 110 through a resin adhesive.

Further, typically, each of the first electrically conductive layer 120 and the second electrically conductive layer 130 is composed of a metal containing aluminum. Thereby, the first current collector 100A including the first electrically conductive layer 120 and the second electrically conductive layer 130 can be suitably used as a positive electrode current collector. The first current collector 100A may be a negative electrode current collector, and each of the first electrically conductive layer 120 and the second electrically conductive layer 130 may be composed of a metal containing copper.

As shown in FIG. 4, the tab portions 140 are arrayed in a winding direction DR of the electrode body 10. The tab portions 140 are away from each other.

Moreover, as shown in FIG. 2, the tab portions 140 are arrayed in the third direction D3. The tab portions 140 are joined to each other by ultrasonic joining or the like. Furthermore, as shown in FIG. 1, the tab portions 140 are joined to the first coupling member 40A by ultrasonic joining or the like. Thereby, the first external terminal 30A is electrically connected with the tab portions 140. Constituents included in each of the tab portions 140 will be described below.

The tab portion 140 is constituted by a film-formed member. Typically, the tab portion 140 is constituted by a metal film containing aluminum or copper.

As shown in FIG. 5A, the tab portion 140 includes a tab body portion 141, a first heat release portion 142, a second heat release portion 143, and a joining assistance portion 144.

The tab body portion 141 is joined to the first electrically conductive layer 120 by ultrasonic welding. The tab body portion 141 extends on the first electrically conductive layer 120 along the orthogonal direction DO (the first direction D1). The tab body portion 141 extends so as to be away from the first electrically conductive layer 120. An extension direction DE of the tab body portion 141 is substantially parallel to the orthogonal direction DO (the first direction D1).

As shown in FIG. 4, the first heat release portion 142 is continuous with the tab body portion 141 in the winding direction DR. The first heat release portion 142 is formed by a member that is integrated with the tab body portion 141. The first heat release portion 142 is shorter than the tab body portion 141, in the extension direction DE of the tab body portion 141.

As shown in FIG. 5B, the first heat release portion 142 is positioned on the opposite side of the first electrically conductive layer 120 from the support layer 110. The first heat release portion 142 is not joined to the first electrically conductive layer 120 by ultrasonic welding. However, the first heat release portion 142 is in contact with the first electrically conductive layer 120.

The second heat release portion 143 is positioned on the opposite side of the support layer 110 from the first electrically conductive layer 120. More specifically, the second heat release portion 143 is positioned on the opposite side of the second electrically conductive layer 130 from the support layer 110. The second heat release portion 143 is not joined to the second electrically conductive layer 130 by ultrasonic welding. However, the second heat release portion 143 is in contact with the second electrically conductive layer 130. The second heat release portion 143 and the first heat release portion 142 are arrayed in the thickness direction DT.

As shown in FIG. 5A, the joining assistance portion 144 is joined to the second electrically conductive layer 130 by ultrasonic welding. The joining assistance portion 144 extends on the second electrically conductive layer 130 along the orthogonal direction DO (the first direction D1). The joining assistance portion 144 extends from the second electrically conductive layer 130 in the extension direction DE. The joining assistance portion 144 is joined also to the tab body portion 141 by ultrasonic welding. The joining assistance portion 144 is shorter than the tab body portion 141 in the extension direction DE. Further, the joining assistance portion 144 and the tab body portion 141 are arrayed in the thickness direction DT. Moreover, the joining assistance portion 144 is continuous with the second heat release portion 143 in the winding direction DR (see FIG. 4). The joining assistance portion 144 is formed by a member that is integrated with the second heat release portion 143.

Each thickness of the tab body portion 141, the first heat release portion 142, the second heat release portion 143, and the joining assistance portion 144 is larger than each thickness of the first electrically conductive layer 120 and the second electrically conductive layer 130. Each thickness of the tab body portion 141, the first heat release portion 142, the second heat release portion 143, and the joining assistance portion 144, for example, preferably should be 20 μm or less, more preferably should be 15 μm or less, and further preferably should be 10 μm or less. Each thickness of the tab body portion 141, the first heat release portion 142, the second heat release portion 143, and the joining assistance portion 144 is not particularly limited as long as there is a desired stiffness. For example, each thickness of the tab body portion 141, the first heat release portion 142, the second heat release portion 143, and the joining assistance portion 144 may be 2 μm or more.

An adhesion member 150 joins a first end portion 142e that is an end portion of the first heat release portion 142 in the extension direction DE and a second end portion 143c that is an end portion of the second heat release portion 143 in the extension direction DE, to each other. The material composing the adhesion member 150 is not particularly limited, and for example, is resin having adhesive property. The resin may contain a metal filler, such that the adhesion member 150 has electric conductivity. In this case, the first end portion 142e is electrically connected with the second end portion 143c.

As shown in FIG. 2 and FIG. 3, the first active material layer 200A is laminated on the first electrically conductive layer 120 and the second electrically conductive layer 130. The first active material layer 200A is a positive electrode active material layer, but may be a negative electrode active material layer. The first active material layer 200A is away from the tab portion 140.

The separator 12 is laminated on the first active material layer 200A in a radial direction from the winding axis line Z.

The first protection portion 400 is composed of a ceramic having electric insulation. As shown in FIG. 5A and others, the first protection portion 400 covers a part that is of the first active material layer 200A laminated on the first electrically conductive layer 120 and that is on a side in the extension direction DE. The first protection portion 400 covers the whole of the surface of the first electrically conductive layer 120 between the first active material layer 200A and the tab body portion 141. The first protection portion 400 is partially disposed also between the first electrically conductive layer 120 and the tab body portion 141.

The second protection portion 500 is composed of a ceramic having electric insulation. The second protection portion 500 covers a part that is of the first active material layer 200A laminated on the second electrically conductive layer 130 and that is on a side in the extension direction DE. The second protection portion 500 covers the whole of the surface of the second electrically conductive layer 130 between the first active material layer 200A and the joining assistance portion 144. The second protection portion 500 is partially disposed also between the second electrically conductive layer 130 and the joining assistance portion 144.

As shown in FIG. 2 and FIG. 3, the second electrode 11B is laminated on the first active material layer 200A through the separator 12 in the above radial direction. In the embodiment, the electrode body 10 includes a plurality of separators 12, but may include a single separator 12.

The second electrode 11B includes a second current collector 100B and a second active material layer 200B. The second current collector 100B includes an electrically conductive support portion 170 and a plurality of second tab portions 180 (see FIG. 3). The electrically conductive support portion 170 extends along the orthogonal direction DO (the first direction D1). The second tab portions 180 extend from an upper end of the electrically conductive support portion 170. The second tab portions 180 are joined to each other by ultrasonic welding, and is joined to the second coupling member 40B (see FIG. 1).

The second tab portions 180 and the electrically conductive support portion 170 are formed of an integrated member, and for example, is formed of a metal film. In the embodiment, the second tab portions 180 and the electrically conductive support portion 170 is composed of a metal containing copper, for example. Thereby, the second current collector 100B can be suitably used as a negative electrode current collector. In the case where the first current collector 100A is a negative electrode current collector and the second current collector 100B is a positive electrode current collector, the second tab portions 180 and the electrically conductive support portion 170 may be composed of a metal containing aluminum.

The second active material layer 200B is laminated on both surfaces of the electrically conductive support portion 170 of the second current collector 100B. In the embodiment, the second electrode 11B is a negative electrode. Therefore, the second active material layer 200B is a negative electrode active material layer. The second active material layer 200B may be a positive electrode active material layer.

As described above, the first current collector 100A according to Embodiment 1 of the present disclosure includes the support layer 110, the first electrically conductive layer 120, and the tab portion 140. The support layer 110 is composed of a resin composition having electric insulation. The first electrically conductive layer 120 is laminated on the support layer 110. The tab portion 140 is constituted by a film-formed member. The tab portion 140 includes the tab body portion 141 and the first heat release portion 142. The tab body portion 141 is joined to the first electrically conductive layer 120 by ultrasonic welding. The tab body portion 141 extends so as to be away from the first electrically conductive layer 120. The first heat release portion 142 is shorter than the tab body portion 141, in the extension direction DE of the tab body portion 141. The first heat release portion 142 is not joined to the first electrically conductive layer 120 by ultrasonic welding.

Because of ultrasonic welding, the energy that is used for the connection between the first electrically conductive layer 120 and the tab portion 140 can be reduced. Moreover, since the tab portion 140 includes the first heat release portion 142, the heat that is generated from the tab body portion 141 at the time of energization is easily released. Further, since the first heat release portion 142 is shorter than the tab body portion 141 in the extension direction DE, the increase in the weight of the first current collector 100A can be restrained. Furthermore, the first heat release portion 142 is not joined to the first electrically conductive layer 120 by ultrasonic welding. Thereby, the tab portion 140 can be easily connected to the first electrically conductive layer 120, by a simple process, regardless of the shape of the first heat release portion 142 that is relatively short in the extension direction DE.

Accordingly, with the above configuration, it is possible to provide the first current collector 100A that restrains heat generation at the time of energization while restraining the increase in production cost and the increase in weight, and the battery 1 including the first current collector 100A.

Further, the above configuration can exert also the following effects. The first heat release portion 142 has the above-described shape, and therefore, in the case where the first heat release portion 142 is also joined to the first electrically conductive layer 120 by ultrasonic welding, it is possible that it is necessary to join an original fabric film to the first electrically conductive layer 120 by ultrasonic welding, and then cut off the tab portion 140 including the first heat release portion 142, from the original fabric film. Therefore, the disposal loss of the original fabric film can become large. With the above configuration, after the tab portion 140 is cut off from the original fabric loss, the tab portion 140 can be easily joined to the first electrically conductive layer 120. Thereby, the freedom degree when the tab portion 140 is cut off from the original fabric film is enhanced, and the reduction in the disposal loss of the original fabric film that is a raw material of the tab portion 140 can be expected.

Moreover, in the embodiment, the first current collector 100A further includes the adhesion member 150. The tab portion 140 further includes the second heat release portion 143. The first heat release portion 142 is positioned on the opposite side of the first electrically conductive layer 120 from the support layer 110. The second heat release portion 143 is positioned on the opposite side of the support layer 110 from the first electrically conductive layer 120. The adhesion member 150 joins the first end portion 142e that is the end portion of the first heat release portion 142 in the extension direction DE and the second end portion 143e that is the end portion of the second heat release portion 143 in the extension direction DE, to each other.

With the above configuration, the heat of the tab portion 140 at the time of energization can be more effectively released by the first heat release portion 142 and the second heat release portion 143.

Further, in the embodiment, the first heat release portion 142 is in contact with the first electrically conductive layer 120.

With the above configuration, at the time of the energization of the first electrically conductive layer 120 and the tab portion 140, an electric current flows through the first heat release portion 142 also, and therefore, it is possible to restrain heat generation at a connection portion between the tab body portion 141 and the first electrically conductive layer 120.

Further, in the embodiment, the second heat release portion 143 is in contact with the second electrically conductive layer 130. The first end portion 142e is electrically connected with the second end portion 143e.

With the above configuration, an electrically conductive path from the second electrically conductive layer 130 to the tab portion 140 can be secured by the second heat release portion 143.

### Embodiment 2

Next, a first current collector and a battery according to Embodiment 2 of the present disclosure will be described. Descriptions about the same configurations and effects as those in Embodiment 1 are not repeated in some cases.

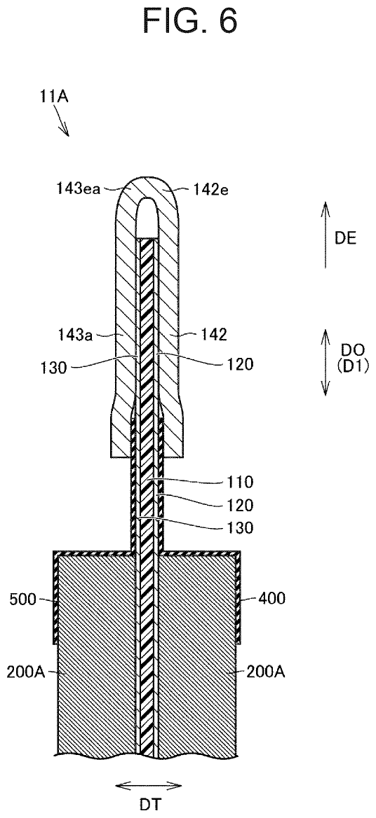

FIG. 6 is a partial sectional view of a first electrode in Embodiment 2. FIG. 6 shows a section from a direction corresponding to the sectional view of FIG. 5B in Embodiment 1. As shown in FIG. 6, in Embodiment 2 of the present disclosure, a second end portion 143ea is directly connected with the first end portion 142e. With the configuration, the second heat release portion 143a can be relatively easily formed by folding a single flat film constituting the tab portion 140, at a portion corresponding to a connection portion between the first end portion 142e and the second end portion 143ea. In the embodiment also, the first end portion 142e is electrically connected with the second end portion 143ea.

In the above descriptions about the embodiments, configurations that can be combined may be mutually combined.

The embodiments disclosed herein should be considered in all respects as illustrative and not restrictive. The scope of the present disclosure is defined by the claims rather than the foregoing description, and is intended to include all changes that fall within the meaning and the scope equivalent to the claims.

What is claimed is:

1. A current collector comprising:
a support layer;
a first electrically conductive layer; and
a tab portion, wherein:
the support layer is composed of a resin composition having electric insulation;
the first electrically conductive layer is laminated on the support layer;
the tab portion is constituted by a film-formed member;
the tab portion includes a tab body portion and a first heat release portion;
the tab body portion is joined to the first electrically conductive layer by ultrasonic welding;
the tab body portion extends so as to be away from the first electrically conductive layer;
the first heat release portion is shorter than the tab body portion, in an extension direction of the tab body portion; and
the first heat release portion is not joined to the first electrically conductive layer by ultrasonic welding.

2. The current collector according to claim 1, further comprising an adhesion member, wherein:
the tab portion further includes a second heat release portion;
the first heat release portion is positioned on an opposite side of the first electrically conductive layer from the support layer;
the second heat release portion is positioned on an opposite side of the support layer from the first electrically conductive layer; and
the adhesion member joins a first end portion and a second end portion to each other, the first end portion being an end portion of the first heat release portion in the extension direction, the second end portion being an end portion of the second heat release portion in the extension direction.

3. The current collector according to claim 1, wherein:
the tab portion further includes a second heat release portion;
the first heat release portion is positioned on an opposite side of the first electrically conductive layer from the support layer;
the second heat release portion is positioned on an opposite side of the support layer from the first electrically conductive layer; and
a second end portion is directly connected with a first end portion, the first end portion being an end portion of the first heat release portion in the extension direction, the second end portion being an end portion of the second heat release portion in the extension direction.

4. The current collector according to claim 2, further comprising a second electrically conductive layer, wherein:
the second electrically conductive layer is laminated on the support layer, so as to be opposed to the first electrically conductive layer;
the first heat release portion is in contact with the first electrically conductive layer;
the second heat release portion is in contact with the second electrically conductive layer; and
the first end portion is electrically connected with the second end portion.

5. A battery comprising:
an electrode body; and
an external terminal, wherein:
the electrode body includes a first electrode, a second electrode, and a separator;
the first electrode includes a current collector and an active material layer;
the current collector includes a support layer, a first electrically conductive layer, and a tab portion;
the support layer is composed of a resin composition having electric insulation;
the first electrically conductive layer is laminated on the support layer;
the tab portion is constituted by a film-formed member;
the tab portion includes a tab body portion and a first heat release portion;
the tab body portion is joined to the first electrically conductive layer by ultrasonic welding;
the tab body portion extends so as to be away from the first electrically conductive layer;
the first heat release portion is shorter than the tab body portion, in an extension direction of the tab body portion;
the first heat release portion is not joined to the first electrically conductive layer by ultrasonic welding;
the active material layer is laminated on the first electrically conductive layer;
the separator is laminated on the active material layer;
the second electrode is laminated on the active material layer through the separator; and
the external terminal is electrically connected with the tab body portion.
